(19) United States
(12) Patent Application Publication
(10) Pub. No.: US 2020/0231294 A1
(43) Pub. Date: Jul. 23, 2020

(54) Method For Assembling An Aircraft Pylon

(71) Applicants: Airbus Operations S.A.S., Toulouse (FR); AIRBUS OPERATIONS LTD, Bristol (GB)

(72) Inventors: François Martinel, Toulouse (FR); Joel Dedieu, Toulouse (FR); Thierry Theron, Toulouse (FR); Julien Moulis, Toulouse (FR); Thomas Deforet, Toulouse (FR); Audrey Benaben, Toulouse (FR); Robert Whiffen, Bristol (GB)

(73) Assignees: Airbus Operations S.A.S., Toulouse (FR); AIRBUS OPERATIONS LTD, Bristol (GB)

(21) Appl. No.: 16/739,322

(22) Filed: Jan. 10, 2020

(30) Foreign Application Priority Data
Jan. 21, 2019 (FR) 19 00502

(51) Int. Cl. B64D 27/26; B64D 27/18

(52) U.S. Cl. CPC B64D 27/26; B64D 2027/262; B64D 27/18

(57) ABSTRACT

A method for assembling an aircraft pylon having a primary structure and at least one internal system at least partially positioned within the primary structure, wherein the internal system is positioned inside the primary structure before the last lateral panel of the primary structure is attached. The absence of one of the lateral panels facilitates the installation of the internal systems.

### FIELD OF THE INVENTION

The present application relates to a method for assembling an aircraft pylon.

### BACKGROUND OF THE INVENTION

According to a configuration shown in FIGS. 1 and 2, an aircraft 10 comprises multiple propulsion units 12 positioned below the wing 14 of the aircraft 10.

A propulsion unit 12 comprises an engine 16, a nacelle (not shown in FIG. 2) positioned around the engine 16, and a pylon 18 that provides the connection between the engine 16 and the wing 14. The pylon 18 comprises a rigid primary structure 20 which, among other things, serves to transmit forces between the engine 16 and the rest of the aircraft 10, a secondary structure 22 which encloses the primary structure 20 and reduces the drag of the pylon 18, and systems located inside and outside the primary structure 20. According to one configuration, the primary structure 20 is connected to the engine 16 by an engine attachment 24 and to the wing 14 by a wing attachment 26.

For the present application, a longitudinal direction X is a direction parallel to the engine axis A16. A horizontal transverse direction Y is a horizontal direction perpendicular to the engine axis A16. A vertical transverse direction Z is a vertical direction perpendicular to the engine axis A16. A vertical longitudinal plane is a plane parallel to the longitudinal direction X and the vertical transverse direction Z.

The terms “front” and “rear” (“Av” and “Ar” respectively) refer to a direction of advance of the aircraft 10 that takes place as a consequence of the thrust produced by the propulsion units 12, this direction being represented by the arrow 28 in FIG. 1.

As shown in FIG. 3, the primary structure 20 comprises:
an upper spar 30,
a lower spar 32,
transverse frames 34 which connect the upper and lower spars 30, 32, which are arranged in transverse planes and which each have an approximately square or rectangular contour,
a front end wall 36 which connects a front end of the upper spar 30 and a front end of the lower spar 32,
a rear end part 38 which connects a rear end of the upper spar 30 and a rear end of the lower spar 32,
two lateral panels 40, 42 arranged on either side of the transverse frames 34.

According to one assembly mode, the various elements of the primary structure (the upper and lower spars 30, 32, the transverse frames 34, the front end wall 36, the rear end part 38 and the lateral panels 40, 42) are assembled so as to obtain a hollow box with closed upper, lower and lateral faces. All that remains after this assembly step is just small openings in the upper and lower spars 30, 32 and in the lateral panels 40, 42, for access to the interior of the primary structure 20.

After this, the systems are positioned within and without the primary structure 20, then the secondary structure 22 is installed.

According to this operating mode, accessibility for installing the systems within the already-assembled primary structure is limited, which can sometimes make the installation of the systems long and complex for the operators.

### BRIEF SUMMARY OF THE INVENTION

The present invention may remedy all or some of the drawbacks of the prior art.

An aspect of the invention relates to a method for assembling an aircraft pylon comprising a primary structure and at least one internal system at least partially positioned within the primary structure, the latter comprising upper and lower spars, transverse frames connecting the upper and lower spars and first and second lateral panels arranged on either side of the transverse frames, characterized in that the assembly method comprises, in chronological order, the steps of:
assembling the primary structure with the exception of at least one of the first and second lateral panels so as to obtain a primary structure of which at least one lateral face is left open,
installing the internal system within the primary structure from the open lateral face of the primary structure, and
attaching one of the first or second lateral panels so as to close each lateral face initially left open.

According to an aspect of the invention, the internal systems are installed more easily, with better visibility for the operators, which makes it possible to reduce the time taken for installation.

According to another feature, only one of the first or second lateral panels is not assembled at the end of the step of assembling the primary structure.

### BRIEF DESCRIPTION OF THE DRAWINGS

Other features and advantages will emerge from the following description of the invention, which description is given solely by way of example, with reference to the appended drawings in which:

FIG. 1 is a side view of an aircraft,

FIG. 2 is a side view of a primary structure of a pylon connecting an engine to a wing, illustrating one embodiment,

FIG. 3 is a perspective exploded view of a primary structure of a pylon,

FIG. 4 is a side view of a partially assembled primary structure of an aircraft pylon, prior to the installation of internal systems positioned within the primary structure, illustrating one embodiment of the invention,

FIG. 5 is a side view of the primary structure shown in FIG. 4, in which there are positioned internal systems, illustrating one embodiment of the invention, and

FIG. 6 is a side view of the primary structure shown in FIG. 4, completely assembled.

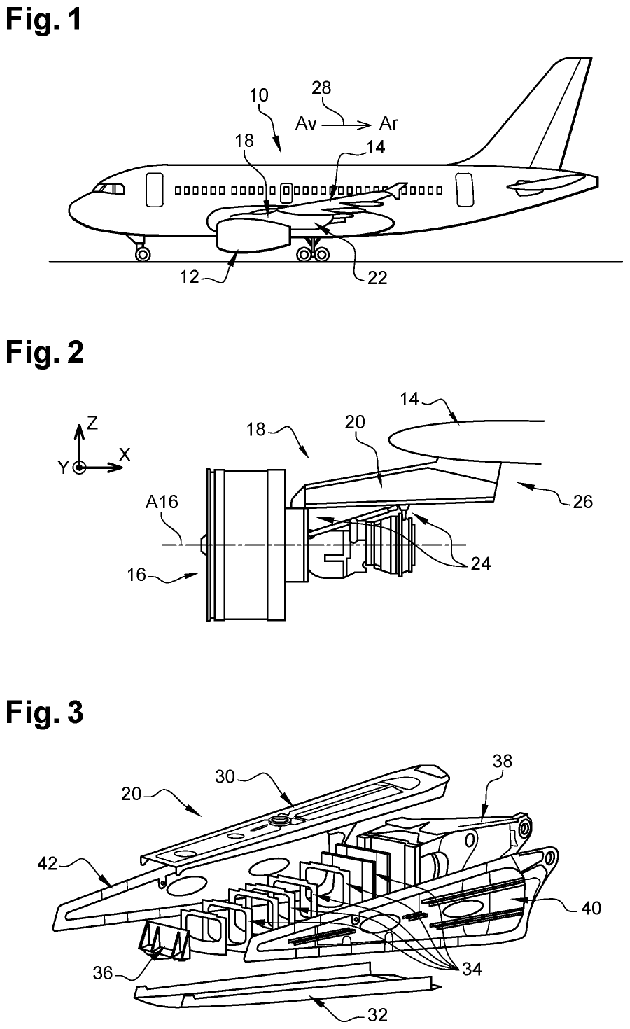

### DETAILED DESCRIPTION

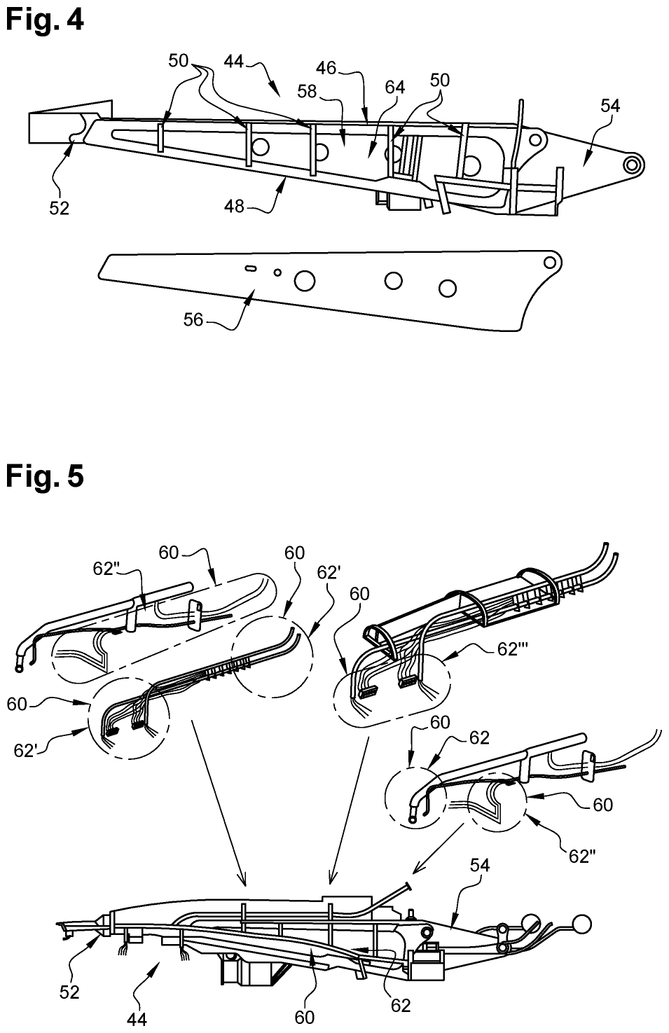

FIGS. 4 to 6 show a primary structure 44 of an aircraft pylon which comprises:
an upper spar 46,
a lower spar 48,
transverse frames 50 which connect the upper and lower spars 46, 48, which are arranged in transverse planes and which each have an approximately square or rectangular contour,
a front end wall 52 which connects a front end of the upper spar 46 and a front end of the lower spar 48,
a rear end part 54 which connects a rear end of the upper spar 46 and a rear end of the lower spar 48,
two lateral panels 56, 58 arranged on either side of the transverse frames 50.

According to one embodiment, the primary structure 44 comprises upper and lower spars 46, 48, transverse frames 50 connecting the upper and lower spars 46, 48 and first and second lateral panels 56, 58 that are arranged on either side of the transverse frames 50.

The aircraft pylon also comprises at least one internal system 60 positioned at least partially within the primary structure 44, at least one external system positioned outside the primary structure 44 and a secondary structure.

As illustrated in FIG. 5, according to one configuration the aircraft pylon comprises multiple internal systems 60 such as pipes 62, cable bundles 62′, a fire extinguishing system 62″, a drainage system 62′″.

The elements forming the primary structure 44, the internal and external systems and the secondary structure are not described in greater detail since they will be known to a person skilled in the art.

The method for assembling the aircraft pylon comprises a first step of assembling the elements of the primary structure 44 with the exception of at least one of the first and second lateral panels 56, 58. According to one operating mode, after the first step only the first lateral panel 56 is not assembled.

After this first step, the upper and lower spars 46, 48, the transverse frames 50, the front end wall 52, the rear end part 54 and the second lateral panel 58 are connected to one another by any appropriate means such as welding, riveting, clinching, adhesive bonding, bolting or other methods.

According to one operating mode, the various elements of the primary structure 44 are pierced independently of one another prior to assembly. They are bolted and/or riveted to one another.

This first assembly is not described in greater detail because the upper and lower spars 46, 48, the transverse frames 50, the front end wall 52, the rear end part 54 and the second lateral panel 58 may be connected to one another in the same way as in the methods of the prior art.

After this first step, the primary structure 44 forms a box of which at least one lateral face 64, that which is ultimately covered by the first lateral panel 56, is left open.

The method for assembling a pylon comprises a second step of installing at least one internal system 60 within the primary structure 44, from the open lateral face 64 of the primary structure 44, in particular by introducing it via the lateral face 64. According to one operating mode, all of the internal systems 60 are positioned inside the primary structure 44 prior to mounting of the first lateral panel 56.

The internal systems 60 are connected to one another and/or to the primary structure 44 and/or to at least one external system and/or to the secondary structure. These connections are not described in greater detail since they are identical to those of the prior art.

According to the invention, the internal system(s) 60 is/are positioned inside the primary structure 44 before the last lateral panel 56, 58 of the primary structure 44 is attached. In the absence of one of the lateral panels 56, 58, the internal systems 60 are installed more easily, with better visibility for the operators, which makes it possible to reduce the time taken for installation.

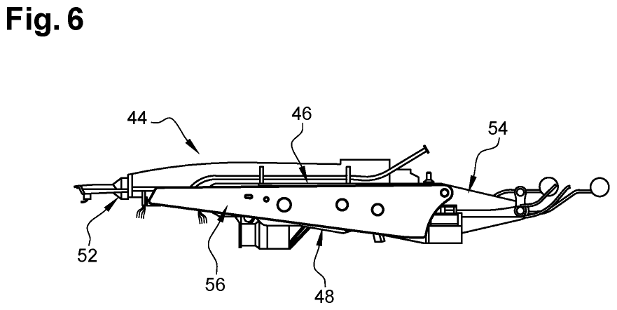

After installation of at least one internal system 60, the method for assembling the pylon comprises, for each initially open lateral face 64, a step of attaching one of the first and second lateral panels 56, 58 to the rest of the primary structure 44, in particular to the upper and lower spars 46, 48, to the transverse frames 50, to the front end wall 52 and/or to the rear end part 54 so as to close each initially open lateral face 64 and to thus obtain a closed box shape as shown in FIG. 6.

Finally, the method for assembling the pylon also comprises at least one step of installing the external systems and the secondary structure.

According to one embodiment, the secondary structure comprises multiple parts. At least one of these may be connected to the primary structure 44 prior to the step of installing the internal system(s) 60 or prior to the step of attaching the first lateral panel 56.

At the end of the assembly method, the primary structure 44 may be identical to that of the prior art. The only difference is the order of the steps of the assembly method.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assembling an aircraft pylon comprising a primary structure, a secondary structure which surrounds the primary structure, at least one internal system at least partially positioned within the primary structure, and at least one external system positioned outside the primary structure, the primary structure comprising upper and lower spars, transverse frames connecting the upper and lower spars and first and second lateral panels arranged on either side of the transverse frames, wherein the assembly method comprises, in chronological order:
assembling the primary structure with the exception of at least one of the first and second lateral panels so as to obtain a primary structure of which at least one lateral face is left open;
installing the internal system within the primary structure from the open lateral face of the primary structure; and
attaching one of the first or second lateral panels so as to close each lateral face initially left open.

2. The method for assembling an aircraft pylon according to claim 1, wherein only one of the first or second lateral panels is not assembled at the end of the step of assembling the primary structure.
